(19) United States
(12) Patent Application Publication
(10) Pub. No.: US 2022/0116747 A1
(43) Pub. Date: Apr. 14, 2022

(54) METHOD AND APPARATUS FOR MAKING A PUSH-TO-TALK CALL

(71) Applicant: MOTOROLA SOLUTIONS, INC., CHICAGO, IL (US)

(72) Inventors: ANOOP SEHGAL PARAS RAM, IPOH (MY); SHEAU WEI CH'NG, BAYAN LEPAS (MY); HUEY NEE CHEAH, BAYAN LEPAS (MY); JIN HOE PHUA, CHENDERIANG (MY)

(21) Appl. No.: 17/067,790

(22) Filed: Oct. 12, 2020

(51) Int. Cl. H04W 4/10; H04W 4/08; H04W 4/02

(52) U.S. Cl. CPC H04W 4/10; H04W 4/027; H04W 4/08

(57) ABSTRACT

A method and apparatus for modifying call timer thresholds for a push-to-talk (PTT) call is provided herein. During operation, a speed of a radio is received, and the call timer thresholds are modified based on the speed of the radio.

### BACKGROUND OF THE INVENTION

A push-to-talk (PTT) call enables a user to communicate with a group of people simultaneously and instantaneously, usually by depressing a PTT button on a user device. Likewise, PTT calls enable users to communicate with one another quickly and spontaneously. This feature is ideal for two people who are working together but are unable to speak with one another directly.

During a PTT call, there are several call timers that are utilized to control the call. For example, a channel hang-time timer (referred to also as a call hang time timer) is utilized to maintain the channel for the particular talkgroup for a threshold period of time after all transmissions have ceased on the talkgroup. In particular, a base station monitors the PTT call, and if there is no activity for a threshold period of time, the base station, in collaboration with other infrastructure elements, will drop the over-the-air channels broadcasting the call to all users. If activity resumes, the base station will then reassign channels (possibly differing channels) to the conversation, and again monitor for inactivity. Thus a channel will be maintained by the infrastructure for the call until no activity has been detected for the threshold period of time.

A re-key-delay timer governs how soon a user can again transmit on the channel after de-keying their radio. In particular, a base station monitors the PTT call, and when a user who is actively transmitting on a channel then de-keys their radio (i.e., stops transmitting), the system will not let the user transmit on the channel again until a predetermined threshold period of time has passed after the radio is de-keyed. This threshold period of time is governed by the re-key delay timer.

Finally, a time-out timer is utilized to prevent a person from transmitting on a channel for longer than a threshold predetermined period of time. For example, a base station monitors a user's transmission on a channel and only allows the user to transmit for a threshold amount of time before the system forces the user's radio to be de-keyed.

While the above timers are utilized in order to efficiently control push-to-talk calls on a system, a problem exists in that the above timers are generally static, while a user experience may be improved by dynamically changing the above-mentioned timers based on various situations encountered by a user. Therefore a need exists for adjusting a call timer based on situations encountered by a user.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 shows an operational environment to adjust call timers.

FIG. 2 is a block diagram of a dispatch application manager.

FIG. 3 is a flow chart showing operation of the dispatch application manager of FIG. 2.

FIG. 4 is a flow chart showing operation of the dispatch application manager of FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for modifying call timer thresholds for a PTT call is provided herein. During operation, a speed of a radio is received, and the call timer thresholds are modified based on the speed of the radio.

In one embodiment of the present invention, as speed increases or decreases, the threshold used for the time-out timer will increase or decrease, respectively. This will ensure that the conversations can flow fast, without a person needlessly occupying the channel. Additionally, as speed increases or decreases the threshold used for the re-key delay timer will also decrease or increase, respectively, so that users are forced to re-key faster during what is potentially a critical situation. Finally, as the speed increases or decreases, the threshold used for the channel hang time timer will increase or decrease, respectively, since a user traveling fast may not have the opportunity to re-key their radio quickly as they concentrate on driving fast.

In a preferred embodiment of the present invention, the timer thresholds have a linear relationship with speed. For example, at 50 mph a time-out timer threshold may be set to 30 seconds, and decrease to 15 seconds at 100 mph. In a similar manner, at 50 mph, a rekey delay timer threshold may be set to 2 second, and decrease to 1 second at 100 mph. In a similar manner, at 50 mph, a channel hang time threshold may be set to 5 seconds, and increase to 10 seconds at 100 mph. Similar changes happen when speed decreases.

It should be noted that upon any change in speed of a device, the timer changes will happen after some cooling period or hysteresis to cater for momentary disruptions to the speed. Therefore, any speed change will only affect call timers after remaining for a certain predetermined period of time.

In alternate embodiments of the present invention, the relationship between speed and the various timer thresholds may take other forms (e.g., logarithmic, asymptotic, exponential, . . . , etc.). Additionally, the relationships between speed and the various timer thresholds may be proportional, or inversely proportional to the speed, so that for example, instead of decreasing with speed, the re-key delay timer threshold may increase as speed increases.

In a first embodiment of the present invention, call timer thresholds for all radios participating in a call will be adjusted based on a radio having a greatest speed. So for example, if only one radio is traveling at, say, 50 mph, then all radios participating in the call will have the same adjustments to their various timer thresholds, regardless of how fast they are traveling. This results in all radios participating in the PTT call to have the same timer thresholds.

In another embodiment of the present invention, call timer thresholds for the radios are tailored individually to each radio. In this scenario, each radio participating in a PTT call will have their various timer thresholds adjusted based on their speed. This results in all radios participating in a PTT call to potentially have differing timer thresholds.

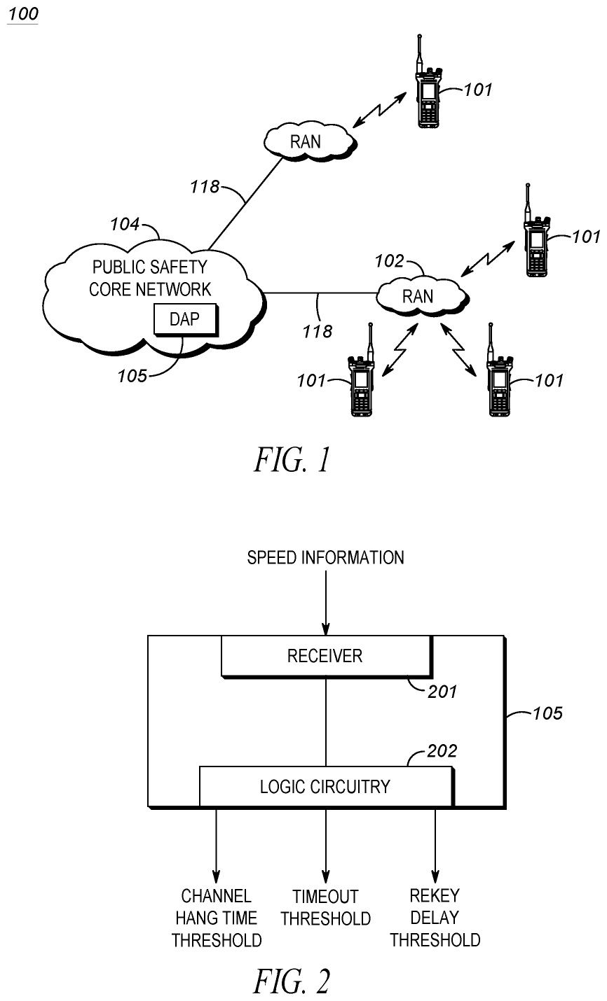

FIG. 1 depicts an example communication system 100 that incorporates dispatch application processor (DAP) 105. It should be noted that the communication system depicted in FIG. 1 comprises a typical public-safety communication system having a modified DAP 105. However one of ordinary skill in the art would recognize that other systems may be modified to encompass DAP 105 such as, but not limited to a cellular communication system, a cloud-based communication system, . . . , etc. System 100 includes one or more radio access networks (RANs) 102, a public-safety core network 104, PTT radio 101, DAP 105, and communication links 118.

RANs 102 includes typical RAN elements such as base stations, base station controllers (BSCs), routers, switches, and the like, arranged, connected, and programmed to provide wireless service to user equipment (e.g., radio 101, and the like) in a manner known to those of skill in the relevant art. RAN 102 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, RAN 102 may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, RAN 102 may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

Public-safety core network 104 may include one or more packet-switched networks and/or one or more circuit-switched networks, and in general provides one or more public-safety agencies with any necessary computing and communication needs, transmitting any necessary public-safety-related data and communications.

For narrowband LMR wireless systems, core network 104 operates in either a conventional or trunked configuration. In either configuration, a plurality of communication devices is partitioned into separate groups (talkgroups) of communication devices. In a conventional narrowband system, each communication device in a group is selected to a particular radio channel (frequency or frequency & time slot) for communications associated with that communication device's group. Thus, each group is served by one channel, and multiple groups may share the same single frequency (in which case, in some embodiments, group IDs may be present in the group data to distinguish between groups using the same shared frequency).

In contrast, a trunked radio system and its communication devices use a pool of traffic channels for virtually an unlimited number of groups of communication devices (e.g., talkgroups). Thus, all groups are served by all channels. The trunked radio system works to take advantage of the probability that not all groups need a traffic channel for communication at the same time.

PTT calls may be made between wireless and/or wireline participants in accordance with either a narrowband or a broadband protocol or standard. Group members for group calls may be statically or dynamically defined. That is, in a first example, a user or administrator may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices 101) could be provisioned in the network by the user or an agent, and then provided some form of group identity or identifier, for example. Then, at a future time, an originating user in a group may cause some signaling to be transmitted indicating that he or she wishes to establish a communication session (e.g., join a group call having a particular talkgroup ID) with each of the pre-designated participants in the defined group. In another example, communication devices may dynamically affiliate with a group (and also disassociate with the group) perhaps based on user input, and the switching and/or radio network may track group membership and route new group calls according to the current group membership.

Radio 101 (sometimes referred to as a mobile device) may be any suitable computing and communication device configured to engage in wireless communication with the RAN 102, and ultimately to other devices over the air interface as is known to those in the relevant art. It should also be noted that any one or more of the communication links 118 could include one or more wireless-communication links and/or one or more wired-communication links.

Expanding on the above, each user of the system may possess a radio to communicate over many differing talkgroups. Communication on various talkgroups will be routed by RAN 102 and network 104 to other devices 101. As discussed above, several timers are utilized to facilitate communication among devices 101 utilizing a talkgroup. In particular, a channel hang-time timer is utilized to maintain the channel for the particular talkgroup for a period of time after all transmissions have ceased on the talkgroup. Thus, after a threshold period of time after all transmissions have ceased, the channel is dropped, allowing for other devices to access the channel. A rekey-delay timer governs how soon a user can again transmit on the channel after de-keying their radio. Thus, a user may not again access a channel after de-keying their radio until after a threshold period of time has passed. Finally, a time-out timer is utilized to prevent a person from transmitting on a channel for longer than a threshold period of time. Thus, the user is automatically de-keyed if they transmit on the channel longer than a threshold. (It should be noted that threshold values for each timer are independent and unique from each other).

In order to facilitate the various call timer thresholds for the multiple devices 101, dispatch-application processor (DAP) 105 is provided. It should be noted that while DAP 105 exists within core network 104, in alternate embodiments DAP 105 may be embodied within RANs 102, or more computing devices in a cloud compute cluster (not shown), or some other communication device not illustrated in FIG. 1, and/or may be a distributed communication device across two or more entities. Regardless of the location of DAP 105, DAP 105 serves to maintain the various call threshold values for each PTT call, and may be configured to drop channels, prevent users from transmitting, prevent users from re-keying, . . . , etc. based on the various threshold values, or simply may be configured to provide timer thresholds to other network equipment so that the other network equipment may drop channels, prevent users from transmitting, prevent users from re-keying, . . . , etc. In other words, the various call timers (and their threshold values) may be maintained by DAP 105, or by any other network entity.

FIG. 2 is a block diagram of DAP 105 configured to determine and provide various call timer thresholds in accordance with one embodiment of the present invention. In this particular embodiment, DAP 105 determines the various call timer thresholds (e.g., the predetermined amount of time used in the various timers to control the PTT calls as described above), and provide these thresholds to network equipment configured to control the PTT calls as described above. As shown, speed information for a mobile unit is received by DAP 105. Based on the speed information DAP 105 determines the various call timer thresholds.

As shown, DAP 105 determines and outputs a channel hang time threshold, which comprises a threshold used to maintain the channel for the particular talkgroup for the threshold after all transmissions have ceased on the talkgroup. Additionally, a re-key delay threshold is determined and output governing how soon a user can again transmit on the channel after de-keying their radio. Thus, the system will not let the user transmit on a channel or talkgroup again until the threshold period of time has passed after the radio is de-keyed. Finally, DAP 105 determines and outputs a time-out threshold that is utilized to prevent a person from transmitting on a channel for longer than the threshold. For example, a base station may monitor a user's transmission on a channel and only allows the user to transmit for the threshold before the system forces the user's radio to be de-keyed.

As discussed, since a user experience may be improved by dynamically changing the above-mentioned thresholds based on various situations encountered by a user. In order to improve user experience, all three timers will have their threshold values set based on a speed of a radio.

In order to modify the various thresholds as described above, DAP 105 comprises receiver 201 and logic circuitry 202. Receiver 201 comprises a network interface that includes elements including processing, modulating, and transceiver elements that are operable in accordance with any one or more standard or proprietary wireless interfaces, wherein some of the functionality of the processing, modulating, and transceiver elements may be performed by means of the processing device 202 through programmed logic such as software applications or firmware or through hardware. Examples of network interfaces (wired or wireless) include Ethernet, T1, USB interfaces, IEEE 802.11b, IEEE 802.11g, etc.

Microprocessor 202 serves as logic circuitry, and comprises a digital signal processor (DSP), general purpose microprocessor, a programmable logic device, or application specific integrated circuit (ASIC) and is configured to determine a speed of a device, and calculate various timer threshold values as described above.

Thus, FIG. 2 shows an apparatus 105 comprising receiver 201, configured to receive information on a speed of a mobile device. This information is preferably sent by the mobile devices as part of normal operations. More specifically, each mobile device is preferably equipped with a GPS receiver capable of determining the device's speed. This speed value is transmitted to the core network and ultimately to DAP 105.

Logic circuitry 202 is provided and configured to adjust a call-timer threshold based on the speed of the mobile device. As discussed, the call-timer threshold is utilized to control at least one of the following, an amount of time a user is allowed to transmit on a channel or talkgroup, an amount of time the channel is maintained after all transmissions have ceased on the talkgroup, and an amount of time a user must not again transmit on the channel after de-keying their radio. Thus, in accordance with an embodiment of the present invention, DAP 105 determines at least one timer threshold, and may determine all three thresholds.

Additionally, the channel comprises a frequency, timeslot, and/or spreading code utilized for communications among radios.

The amount of time the user is allowed to transmit on the channel may decrease as the speed of the mobile device increases, and increase as the speed of the mobile device decreases. Additionally, the amount of time the channel is maintained after all transmissions have ceased on the talkgroup may be increased as the speed of the mobile device increases, and decreased as the speed of the mobile device decreases. Finally, the amount of time a user must not again transmit on the channel after de-keying their radio may decrease as the speed of the mobile device increases, and increase as the speed of the mobile device decreases.

Thus, as described, FIG. 2 illustrates an apparatus comprising receiver 201, configured to receive information on a speed of a mobile device, and logic circuitry 202 configured to adjust a call-timer threshold based on the speed of the mobile device. As described, the call-timer threshold is utilized to control at least one of:
an amount of time a user is allowed to transmit on a channel or talkgroup;
an amount of time the channel is maintained after all transmissions have ceased on the talkgroup; and
an amount of time a user must not again transmit on the channel after de-keying their radio.

As described above, the channel comprises a frequency, timeslot, and/or spreading code utilized for communications among radios. Additionally, the amount of time the user is allowed to transmit on the channel may decrease as the speed of the mobile device is increased, and increased as the speed of the mobile device is decreased. Additionally, the amount of time the channel is maintained after all transmissions have ceased on the talkgroup may be increased as the speed of the mobile device increases, and decreased as the speed of the mobile device decreases. Finally, the amount of time a user must not again transmit on the channel after de-keying their radio may be decreased as the speed of the mobile device increases, and increased as the speed of the mobile device decreases.

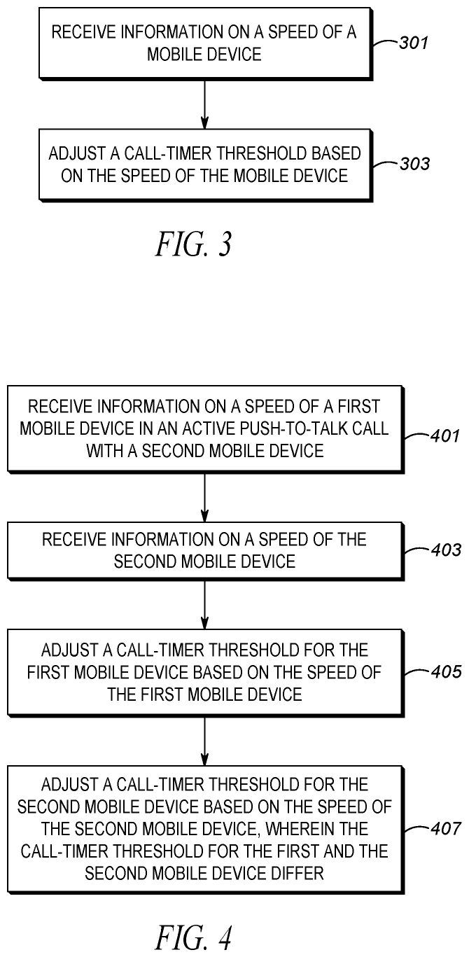

FIG. 3 is a flow chart showing operation of the DAP 105. The logic flow begins at step 301 where receiver 201 receives information on a speed of a mobile device and passes this information to logic circuitry 203. At step 303, logic circuitry 203 adjusts a call-timer threshold based on the speed of the mobile device. As discussed, the call-timer threshold is utilized to control at least one of an amount of time a user is allowed to transmit on a channel or talkgroup, an amount of time the channel is maintained after all transmissions have ceased on the talkgroup, and an amount of time a user must not again transmit on the channel after de-keying their radio.

FIG. 4 is a flow chart showing operation of the device of FIG. 2. The logic flow begins at step 401 where receiver 201 receives information on a speed of a first mobile device in an active push-to-talk call with a second mobile device. At step 403, receiver 201 receives information on a speed of the second mobile device. The speed information of the first and the second devices is passed to logic circuitry 202. At step 405, logic circuitry 202 adjusts a call-timer threshold for the first mobile device based on the speed of the first mobile device, and at step 407, adjusts a call-timer threshold for the second mobile device based on the speed of the second mobile device. In one embodiment, the call-timer threshold for the first and the second mobile device differ.

As discussed above, the call timer thresholds are utilized to control at least one of an amount of time a user is allowed to transmit on a channel or talkgroup, an amount of time the channel is maintained after all transmissions have ceased on the talkgroup, and an amount of time a user must not again transmit on the channel after de-keying their radio.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a receiver, configured to receive information on a speed of a mobile device;
logic circuitry configured to adjust a call-timer threshold based on the speed of the mobile device, wherein the call-timer threshold is utilized to control at least one of the following:
an amount of time a user is allowed to transmit on a channel or a talkgroup;
an amount of time the channel is maintained after all transmissions have ceased on the talkgroup; and
an amount of time a user must not again transmit on the channel after de-keying their radio.

2. The apparatus of claim 1 wherein the channel comprises a frequency, timeslot, and/or spreading code utilized for communications among radios.

3. The apparatus of claim 1 wherein the amount of time the user is allowed to transmit on the channel decreases as the speed of the mobile device increases, and increases as the speed of the mobile device decreases.

4. The apparatus of claim 1 wherein the amount of time the channel is maintained after all transmissions have ceased on the talkgroup is increased as the speed of the mobile device increases, and decreased as the speed of the mobile device decreases.

5. The apparatus of claim 1 wherein the amount of time a user must not again transmit on the channel after de-keying their radio decreases as the speed of the mobile device increases, and increases as the speed of the mobile device decreases.

6. A method comprising the steps of:
receiving information on a speed of a mobile device;
adjusting a call-timer threshold based on the speed of the mobile device, wherein the call-timer threshold is utilized to control at least one of the following:
an amount of time a user is allowed to transmit on a channel or a talkgroup;
an amount of time the channel is maintained after all transmissions have ceased on the talkgroup; and
an amount of time a user must not again transmit on the channel after de-keying their radio.

7. The method of claim 6 wherein the channel comprises a frequency, timeslot, and/or spreading code utilized for communications among radios.

8. The method of claim 6 wherein the amount of time the user is allowed to transmit on the channel decreases as the speed of the mobile device increases, and increases as the speed of the mobile device decreases.

9. The method of claim 6 wherein the amount of time the channel is maintained after all transmissions have ceased on the talkgroup is increased as the speed of the mobile device increases, and is decreased as the speed of the mobile device decreases.

10. The method of claim 6 wherein the amount of time a user must not again transmit on the channel after de-keying their radio decreases as the speed of the mobile device increases, and increases as the speed of the mobile device decreases.

11. A method comprising the steps of:
receiving information on a speed of a first mobile device in an active push-to-talk call with a second mobile device;
receiving information on a speed of the second mobile device;
adjusting a call-timer threshold for the first mobile device based on the speed of the first mobile device;
adjusting a call-timer threshold for the second mobile device based on the speed of the second mobile device, wherein the call-timer threshold for the first and the second mobile device differ, and are utilized to control at least one of the following:
an amount of time a user is allowed to transmit on a channel or a talkgroup;
an amount of time the channel is maintained after all transmissions have ceased on the talkgroup; and
an amount of time a user must not again transmit on the channel after de-keying their radio.

12. The method of claim 11 wherein the channel comprises a frequency, timeslot, and/or spreading code utilized for communications among radios.

13. The method of claim 11 wherein the amount of time the user is allowed to transmit on the channel decreases as the speed of the mobile device increases, and increases as the speed of the mobile device decreases.

14. The method of claim 11 wherein the amount of time the channel is maintained after all transmissions have ceased on the talkgroup is increased as the speed of the mobile device increases, and decreased as the speed of the mobile device decreases.

15. The method of claim 11 wherein the amount of time a user must not again transmit on the channel after de-keying their radio decreases as the speed of the mobile device increases, and increases as the speed of the mobile device decreases.
